(19) United States
(12) Patent Application Publication
(10) Pub. No.: US 2015/0173565 A1
(43) Pub. Date: Jun. 25, 2015

(54) INTEGRATED UNIT-OPERATIONS FOOD-PROCESSING APPARATUS

(71) Applicant: NESTEC S.A., Vevey (CH)

(72) Inventor: Constantine Sandu, Solon, OH (US)

(21) Appl. No.: 14/407,157

(22) PCT Filed: Jun. 27, 2013
(86) PCT No.: PCT/EP2013/063475

§ 371 Date: Dec. 11, 2014

Related U.S. Application Data
(60) Provisional application No. 61/666,180, filed on Jun. 29, 2012.

(51) Int. Cl. A47J 43/06; H05B 6/80; A47J 44/00

(52) U.S. Cl. CPC A47J 43/06; A47J 44/00; H05B 6/80

(57) ABSTRACT

The invention relates to a food-processing apparatus comprising a processing vessel and at least 4 flow loops for unit operations, wherein the flow loops each comprises a product inlet, a product outlet, and a pumping device for circulating the product through the flow loop; the flow loops are directly installed on the processing vessel and in communication with the processing vessel. In preferred embodiment the apparatus comprises a reactor-vessel flow loop; a top-head flow loop; a high-shear flow loop; a direct-cooling flow loop; a direct-heating flow loop; and a temporary-surge flow loop. The invention also relates to use of the food-processing apparatus for the processing of liquid food.

The present invention generally relates to food processing. More specifically, the invention relates to an apparatus based upon integrated unit-operations for food processing.

### BACKGROUND

It is known in the food processing industry to use processing vessels having the capability to provide, for example, heating and cooling within the processing vessel, respectively, agitation-mixing and dispersion-emulsification. The integration of these unit operations is extremely important for process control, performance of the equipment, and to provide efficient, flexible batching of food products. Currently, the food processing industry does not provide a food processing apparatus that is capable of combining a larger number of integrated unit-operations, able of speeding the batching of food product and providing other integration advantages including, for example, fast, efficient cleaning-in-place.

Accordingly, there exists a need for an apparatus that is designed to employ a combination of integrated unit-operations, more than one unit operation at a time, in a logical manner that allows for efficient, fast, flexible, and economical batching in food processing. It is therefore an object of the invention to provide such an apparatus, or useful alternatives to existing apparatuses.

### SUMMARY

In a first aspect, the invention relates to a food-processing apparatus comprising a processing vessel and at least 4 flow loops for unit operations, wherein the flow loops each comprises a product inlet, a product outlet, and a pumping device for circulating the product through the flow loop; the flow loops are directly installed on the processing vessel and in communication with the processing vessel. The food-processing apparatus preferable has at least 6 flow loops. Further, the apparatus preferably comprises flow loops selected from the group consisting of: a reactor-vessel flow loop; a top-head flow loop; a high-shear flow loop; a direct-cooling flow loop; a direct-heating flow loop; and a temporary-surge flow loop; or combinations thereof. In a preferred embodiment of the invention the food-processing apparatus comprises one of each of the mentioned flow loops.

In an embodiment of invention, the reactor-vessel flow loop comprises at least one device selected from the group consisting of: a processing vessel; a pumping device; sonotrodes; a steam-injection nozzle; pipe port-connections; and vibratory-shear devices; or a combination thereof.

In an embodiment of invention, the top-head flow loop comprises at least one device selected from the group consisting of: a top head; a cooling device; a vacuum connection; a spray pipe in conjunction with the pumping device; a cleaning device; and a vibratory-shear device; or a combination thereof.

In an embodiment of invention, the high-shear flow loop, adapted to work as a recession to processing vessel, comprises a high-shear device, at least one hopper, and at least one vibratory-shear device installed at each hopper.

In an embodiment of invention, the direct-cooling flow loop, adapted to work as a recession to processing vessel, comprises at least one device selected from the group consisting of: a pumping device; a liquid-nitrogen injection nozzle; a microwave measurement device; and in-process instrumentation; or a combination thereof.

In an embodiment of invention, the direct-heating flow loop, in fluid communication with processing vessel, comprises at least one device selected from the group consisting of: a direct-heating device operating based on steam-energy-injection, or ultrasound-energy-injection, or microwave-energy-injection; and a circulation pump; or a combination thereof.

In an embodiment of invention, the temporary-surge flow loop, arranged to be in fluid communication with processing vessel, comprises at least one device selected from the group consisting of: a transfer vessel; a transfer pump; a rotating pumping device; a steam-injection nozzle; a series of cleaning-in-place spray balls; and at least one vibratory-shear device; or a combination thereof.

In an embodiment of invention, the pumping device is a double-cone pumping device. Preferably the double-cone pumping device comprises: a rotating flat disc; two rotating cones, as full physical bodies, with their large bases on the opposite faces of the rotating flat disc; and at least two rotating vanes located symmetrically onto the opposite sides of the rotating flat disc. Advantageously, the double-cone pumping device is part of a cleaning-in-place system.

In an embodiment of invention, the high-shear device comprises: a stator featuring two concentric rings having a plurality of axis-parallel teeth, and located inside processing vessel; a rotor featuring two concentric rings having a plurality of axis-parallel teeth, whose concentric rings intermesh with the concentric rings of the stator; and at least one rotating vane inside the rotor, which acts as an impeller of a centrifugal pump, which allows liquid intake from both sides of the impeller.

The steam-injection nozzle in the reactor vessel flow loop is advantageously a supersonic steam-injection device. A particular preferred design is a supersonic steam-injection device that has a nozzle throat with a rectangular opening, allowing steam that flows through the rectangular opening at the nozzle throat to be introduced into a diverging section, inside a processing vessel, and which steam-injection device is adapted to form an external asymmetrical boundary layer of the steam jet at the inner of the sidewall of processing vessel.

In an embodiment of the invention, the processing vessel is heated by means of a microwave batch-heating assembly which comprises: a microwave guide installed to processing vessel; a microwave-transparent window installed into the wall of processing vessel; and a rotating pumping device installed inside processing vessel.

In an embodiment of invention, the top head flow loop is provided with a vibratory enhanced cooling assembly comprising cooling devices which are arranged to be lowered, respectively, lifted from the processing vessel.

In another aspect, the invention relates to the use of a food-processing apparatus according to any of the preceding claims for the processing of liquid food.

Additional features and advantages are described herein, and will be apparent from the following Detailed Description and the figures.

### BRIEF DESCRIPTION OF THE FIGURES

FIG. 1 illustrates a full view of an apparatus in accordance with an embodiment of the invention.

FIG. 2 illustrates a cross-sectional view of an apparatus in accordance with an embodiment of the invention.

FIG. 3 illustrates a reactor-vessel flow loop of an apparatus in accordance with an embodiment of the invention.

FIG. 4 illustrates a top-head flow loop of an apparatus in accordance with an embodiment of the invention.

FIG. 5 illustrates a high-shear flow loop of an apparatus in accordance with an embodiment of the invention.

FIG. 6 illustrates a direct-cooling flow loop of an apparatus in accordance with an embodiment of the invention.

FIG. 7 illustrates a direct-heating flow loop of an apparatus in accordance with an embodiment of the invention.

FIG. 8 illustrates a temporary-surge flow loop of an apparatus in accordance with an embodiment of the invention.

FIG. 9 illustrates a double-cone pump in accordance with an embodiment of the invention.

FIG. 10 illustrates a microwave batch-heating assembly in accordance with an embodiment of the invention.

FIG. 11 illustrates a vibratory-enhanced indirect-cooling assembly in accordance with the invention.

FIG. 12 illustrates a high-velocity spraying assembly for cleaning-in-place in accordance with the invention.

### DETAILED DESCRIPTION

Integrated Unit-Operations

The integrated unit-operations concept of the apparatus in this invention is concerned with unit operations (or functions) known to be employed in food processing. For example, unit operations for sauce manufacture may include, but are not limited to, ingredient feeding, sugar dissolution, powder incorporation, micronization, emulsification, starch gelatinization, protein hydration, fiber hydration, aroma and color buildup, heating, cooling, vacuum treatment, etc. While a singular piece of equipment or a singular process may be used to accommodate each of the unit operations on the list, it is possible that an equipment or process can accomplish more than one unit operation. The apparatus in this invention is designed so that the unit operations in the manufacture of liquid food products, e.g. sauces, are physically embedded into the apparatus itself, with a minimum amount of piping network.

The design of the apparatus claimed in this invention provides characteristics that are important when constructing integrated unit-operations into industrial equipment aimed at fast, flexible, and economical manufacture of food products. These characteristics may include, but are not limited to, a well-stirred reactor; an enhanced-shear reactor; an enhanced process-rates reactor; a fast-heating reactor; a fast-cooling reactor; an advanced process-instrumentation reactor; and a rapid-efficient-cleaning reactor.

Another advantage of the apparatus of this invention is that the integrated unit-operations apparatus comprises a series of flow loops, whereby a flow loop is defined as a physical region, within or directly connected with the apparatus, which features a closed flow-pattern, under the action of a dedicated pumping device.

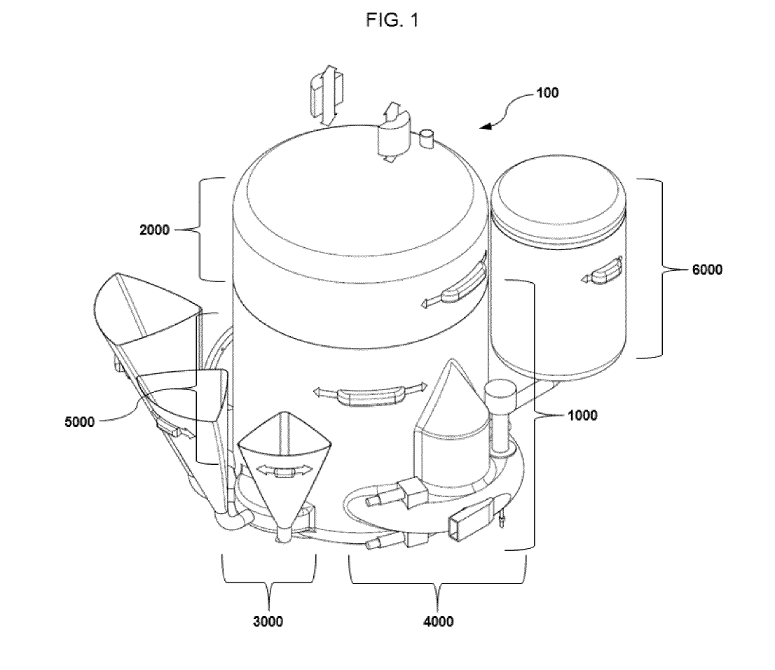

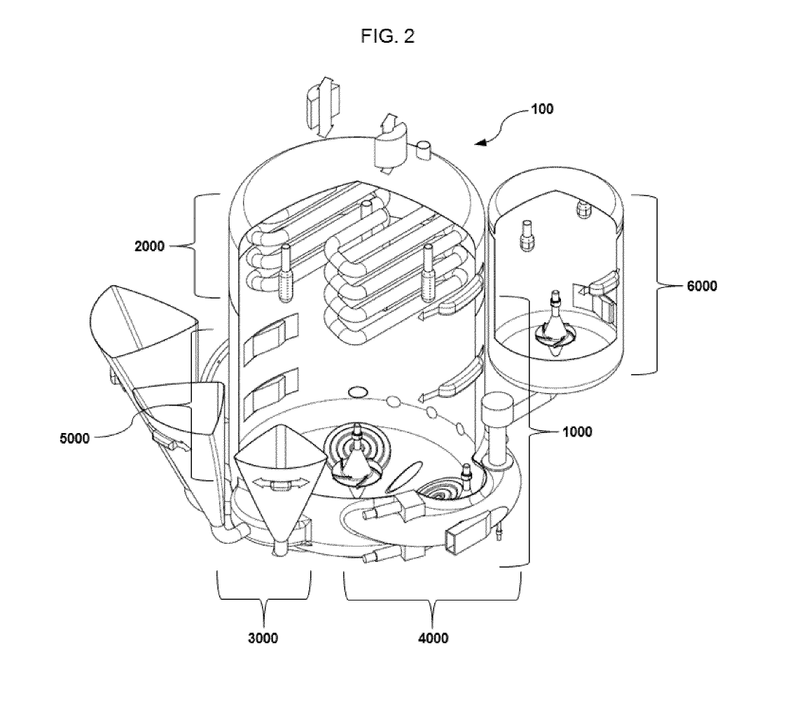

An apparatus 100 in accordance with an embodiment of the invention is illustrated in FIGS. 1 and 2. The apparatus 100 comprises six major flow loops integrated to allow for efficient, fast, flexible, and economical batching: a reactor-vessel flow loop 1000 as a main mechanical structure, comprising a processing vessel; a top-head flow loop 2000 as an extension to the processing vessel; a high-shear flow loop 3000 as a recession at the bottom of the processing vessel; a direct-cooling flow loop 4000 as a recession at the bottom of the processing vessel; a direct-heating flow loop 5000 in fluid communication with the processing vessel; and a temporary-surge flow loop 6000 in fluid communication with the processing vessel. The top-head flow loop, high-shear flow loop, and direct-cooling flow loop may be in an un-obstructed communication with the reactor-vessel flow loop, and it is preferred that there is no piping network connecting each one of these flow loops with the reactor-vessel flow loop. For example, the top-head flow loop is an extension of the processing vessel, while the high-shear flow loop and direct-cooling flow loop are preferably made of the two recessions at the bottom of the processing vessel. On the other hand, the direct-heating flow loop and temporary-surge flow loop may be externally mounted to the reactor-vessel flow loop; in direct fluid communication with the processing vessel, but requiring a minimum of piping network as shown in FIGS. 1 and 2.

The reactor-vessel flow loop 1000 is under the action of the large double-cone pump 1200; the top-head flow loop 2000 is equally activated by the large double-cone pump 1200, when in conjunction with the glycol cooling coils 2300 (during second stage of cooling), or when in conjunction with the spray pipe 2700 (during cleaning); the pumping device within the high-shear flow loop 3000 is made of the enhanced high-shear device 3100; the pumping device associated with the direct-cooling flow loop 4000 is preferably made of the small double-cone pump 4100; the direct-heating flow loop 5000 is activated by the circulation pump 5200; while the flow action inside the temporary-surge flow loop 6000 is ensured by the small double-cone pump 6200.

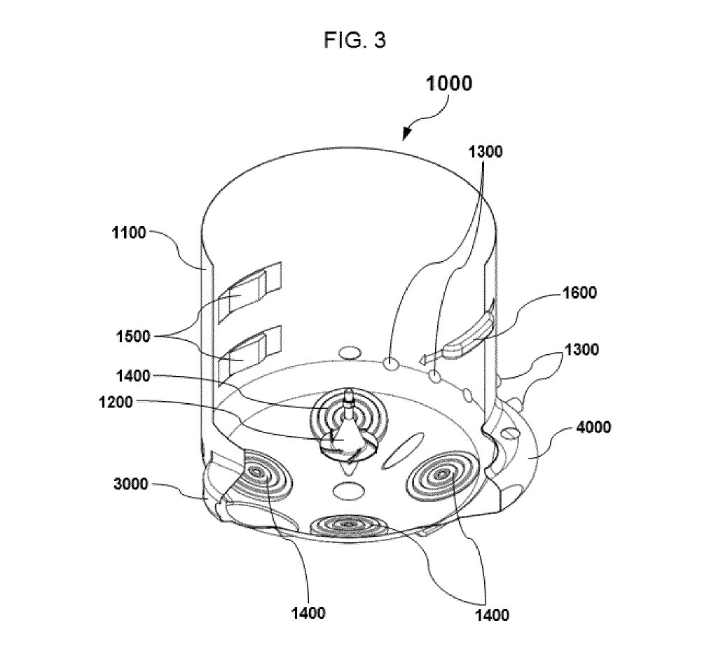

The reactor-vessel flow loop 1000 is shown in FIG. 3. It includes a processing vessel 1100, within which the entire batching is conducted. The processing vessel 1100 constitutes the mechanical structure that allows a complete integration of the hydro- and thermo-dynamic unit operations. Processing vessel 1100 may have a cylindrical shape, with two main recessions, located towards its base. One recession accommodates the high-shear flow loop 3000, while the other one provides for the direct-cooling flow loop 4000. Mixing-agitation inside the processing vessel 1100 is ensured by the large double-cone pump 1200 having a variable frequency drive; the large double-cone pump 1200 can be moved axially, up-and-down, at various locations inside the processing vessel 1100. Liquid ingredients may be brought into processing vessel 1100 through liquid ports 1300. The remaining devices in FIG. 3 may be directly installed in the wall of the processing vessel 1100 and include, for example, high-power sonotrodes 1400, supersonic steam-injection nozzles 1500, and vibratory-shear devices 1600.

In the context of the present invention, one needs to make the distinction between a high-power sonotrode and a vibratory-shear device: The former is an ultrasound device operating on the mechanism of piezoelectric and/or magnetostrictive materials; the latter is a vibratory device operated pneumatically, mechanically, electromagnetically, or like an ultrasound generator. Also, a sonotrode in this invention is always meant to be a high-power device; by comparison, a vibratory device operates at medium and low power levels.

High-power sonotrodes 1400 are typical ultrasound generators (operating with acoustic cavitation) utilized for ingredient micronization and emulsification. In the design of the present apparatus 100, supersonic steam-injection nozzles 1500 may be utilized for heating since they are ultrasound generators operating on the concept of acoustic cavitation, also. By comparison, vibratory-shear devices 1600 induce an azimuthal (or, around axis) oscillation to processing vessel 1100 to which they are attached; they are installed on the outside of processing vessel 1100. Their purpose is to induce vibratory shear at the liquid-solid interface, respectively, to enhance material-releasing and cleaning. The vibratory shear acts upon the velocity boundary layers.

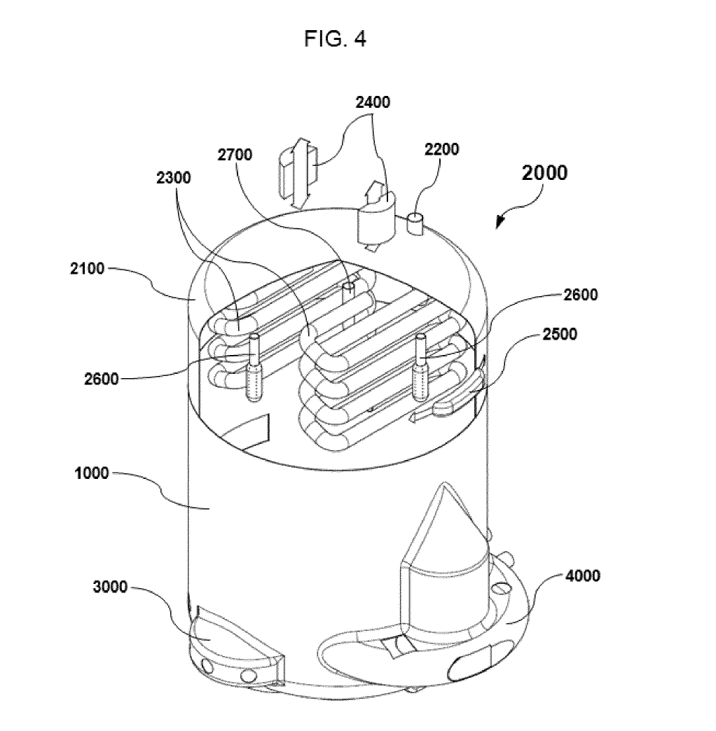

A top-head flow loop 2000 according to an embodiment of the invention is shown in FIG. 4. It consists of the top head 2100, within which the means for indirect cooling, cleaning-in-place, and vacuum connection may be located. The food product doesn't come in contact with top-head flow loop 2000 at any time during batching. Instead, when the time for a second cooling stage comes, glycol cooling coils 2300 can be lowered into processing vessel 1100 where the cooling of the product takes place. In addition to being able to move up and down, axially, between the locations in top head 2100 and processing vessel 1100, glycol cooling coils 2300 are provided with vibratory-shear devices 2400. These devices enhance the heat transfer coefficient by acting upon the velocity and thermal boundary layers associated with the heat transfer through the surface of the coil. The other parts associated with top-head flow loop 2000 include, but are not limited to, vibratory-shear devices 2500, spray devices (e.g., spray balls) 2600, and spray pipe 2700. Vibratory-shear devices 2500 installed on the outside of top head 2100 play the same role as vibratory-shear devices 1600 installed on processing vessel 1100. Spray balls 2600 are part of the cleaning-in-place (“CIP”) system. By comparison, spray pipe 2700 is designed to move up and down, in tandem with large double-cone pump 1200, along the axis of the processing vessel 1100, during the CIP procedure. The liquid supplied by spray pipe 2700 falls directly onto the high-speed, rotating disc of large double-cone pump 1200; that is, large double-cone pump 1200 may be used as a high-velocity spraying device itself.

The top head 2100 can be lifted from the processing vessel 1100 and moved up and down to conduct various functions during the batching process. As far as the effective separation of the liquid phase from the water vapor is concerned, the top-head flow loop 2000 is designed with a large cross sectional area that allows for lower flow velocities of the water vapor, implicitly, good separation of the liquid product droplets, during vacuum treatment. The vacuum operation is facilitated by the vacuum connection 2200; see FIG. 4.

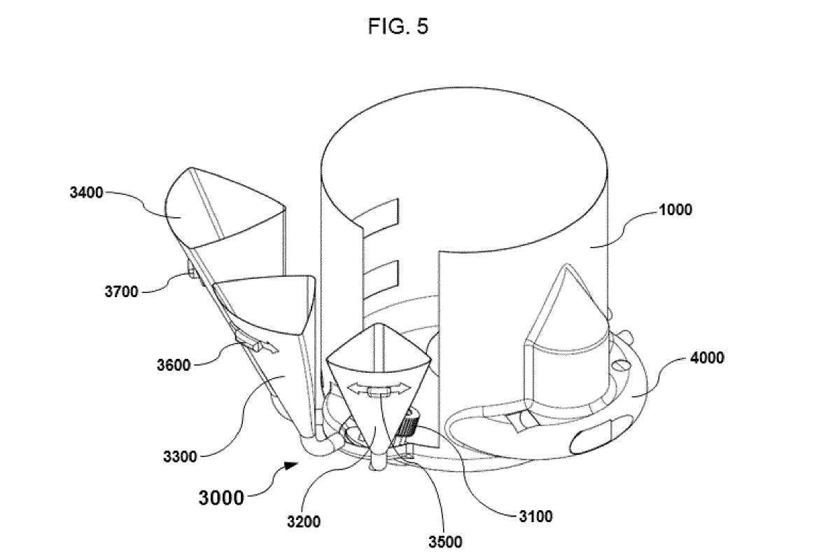

High-shear flow loop 3000 of FIG. 5 may play a multiple role in ingredient incorporation, micronization, and emulsification. Given the way in which it is designed and operated, high-shear flow loop 3000 is highly versatile; especially, when high-shear flow loop 3000 is operated in conjunction with the vacuum capability of the present apparatus 100. The main component of high-shear flow loop 3000 is an enhanced high-shear device 3100 located in a recession at the bottom of processing vessel 1100. Hoppers 3200, 3300, 3400 are directly installed by the high-shear flow loop 3000, and provide for incorporation of various powder or liquid ingredients into the batching. To enhance both the material release and the cleaning process, each hopper is fitted with a vibratory-shear device 3500, 3600, and 3700.

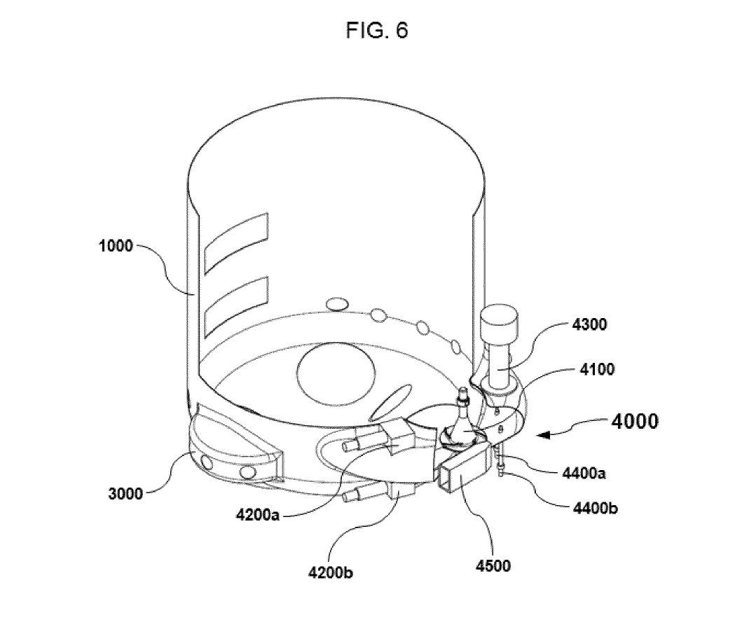

Direct-cooling flow loop 4000 of FIG. 6 may be designed to accommodate both nitrogen-injection cooling of the product in processing vessel 1100, and the location of the in-process instrumentation to measuring the product & quality parameters of the food product during and immediately at the end of batching.

Liquid-nitrogen injection may be utilized during an initial cooling stage, to a temperature of about 120° F. to about 125° F. At these temperatures, the product inside processing vessel 1100 is expected to be rather less viscous and thus less prone to formation of stable foam, with the nitrogen gas. During the initial cooling stage, top head 2100 may be lifted above processing vessel 1100, in order to prevent any pressure buildup inside processing vessel 1100. At the same time, vacuum, through vacuum connection 2200, may be applied for the purpose of removing the nitrogen gas released during cooling with liquid nitrogen. When the initial cooling stage is completed, processing vessel 1100 is closed and vacuum is applied for entirely removing the nitrogen gas from the product inside processing vessel 1100. The purpose of direct-cooling flow loop 4000 is to facilitate the flow of both the liquid product and the liquid/gas nitrogen at volumetric flow rates that are comparable in magnitude. The volumetric flow rate of the liquid product inside direct-cooling flow loop 4000 is locally increased by a small double-cone pump 4100, while the liquid nitrogen that becomes a gas is brought into direct-cooling flow loop 4000 by the liquid-nitrogen injection nozzle 4500. The flow associated with liquid-nitrogen injection nozzle 4500 is very complex, since the flow involves a change of phase (i.e., liquid to gas) at possibly supersonic flow conditions; just oppositely when compared with the flow through supersonic steam-injection nozzles 1500, which implies a gas to liquid change of phase.

The basic approach to in-process instrumentation for the food processing apparatus 100 originates with the locally high flow (i.e., high shear) created within the direct-cooling flow loop 4000. Within this flow loop, a locally high hydrodynamic shear is generated by the small double-cone pump 4100, where all in-process instrumentation is installed, and where the contact surfaces or tips of the corresponding instrumentation can be maintained free of fouling deposition. There may be any number of measurement devices installed on the direct-cooling flow loop 4000; for instance, a soluble-solids measurement device 4300, and a color measurement device featuring two probes 4400a and 4400b. In an embodiment, there may be a moisture microwave-measurement 4200, where the transmitter 4200a and receiver 4200b, installed in a plane-parallel geometry, need to come directly in contact with the liquid product flowing in-between. In an embodiment, the small double-cone pump 4100 itself can be calibrated to measure the viscosity of the liquid product inside processing vessel 1100.

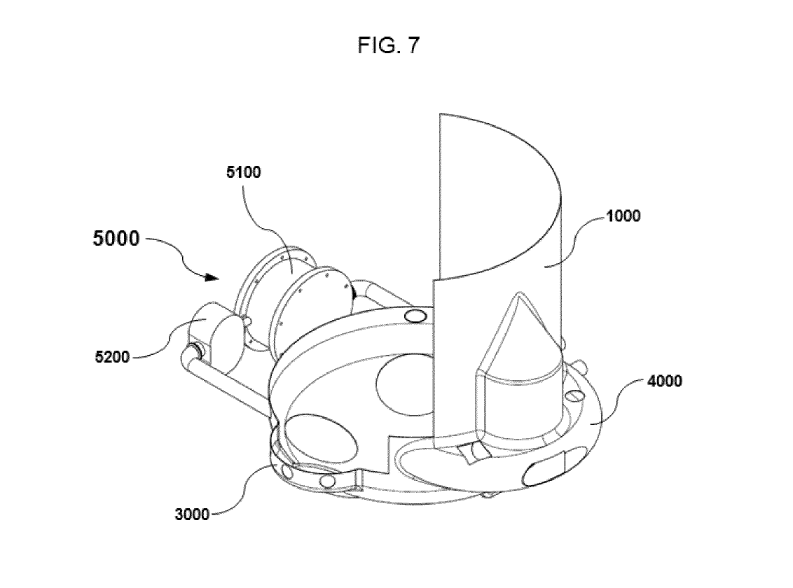

Direct-heating flow loop 5000, as shown in FIG. 7, may be provided for both the heating of low-viscosity products that have a significant excess of water in their formula and the heating of highly viscous products featuring lower moisture contents. The core of the direct-heating flow loop 5000 may be a heat exchanger 5100. Heat exchanger 5100 may be any of the exchangers that operate on the concept of direct volumetric heating like steam-energy-injection, ultrasound-energy injection, or microwave-energy injection. Since most heat exchangers 5100 do not have measurable pumping capacities, a circulation pump 5200 may advantageously be installed on the same flow loop. Alternatively, heat exchanger 5100 may be used for additional heating in conjunction with the supersonic steam-injection nozzles 1500 installed on the processing vessel 1100.

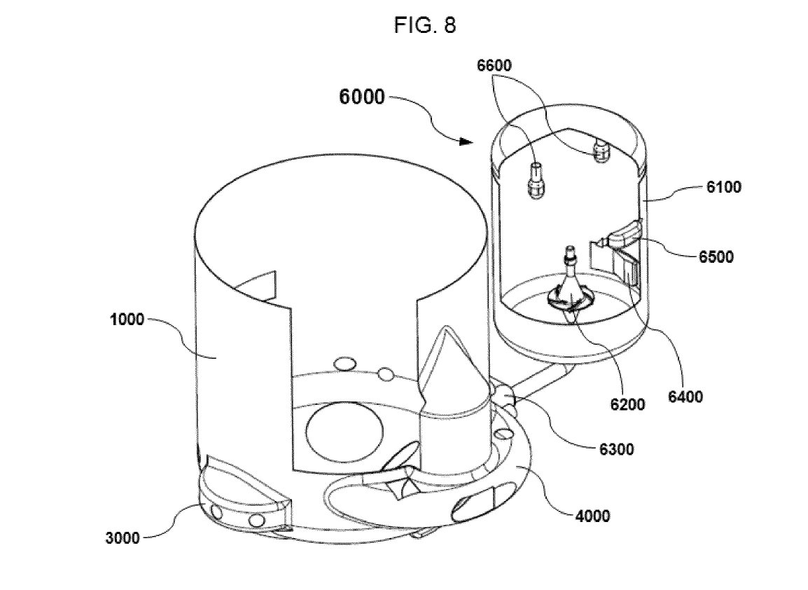

Temporary-surge flow loop 6000 of FIG. 8 offers high flexibility in the sequencing of batching. For instance, after an emulsion is prepared in processing vessel 1100, the emulsion can be pumped to a temporary transfer vessel 6100 where it can be stored for an amount of time. If necessary, the emulsion can be brought back into processing vessel 1100 at another stage of the batching process. In an embodiment, and to minimize the piping network, there may be only one connection between processing vessel 1100 and temporary transfer vessel 6100. A transfer pump 6300 may be provided on this pipe connection. The transfer pump 6300 may be a positive displacement type (e.g., a Waukesha pump, from Waukesha Cherry-Burrell) that operates in one direction to assist the transfer of the liquid from vessel 1100 to vessel 6100, whereby reversing the rotational direction the liquid can be brought back from vessel 6100 to vessel 1100. Other parts associated with the temporary-surge flow loop 6000 may include, but are not limited to, a small double-cone pump 6200, a steam-injection nozzle 6400, a vibratory-shear device 6500, and CIP spray devices (e.g., spray balls) 6600.

Cleaning-in-place (“CIP”) is another advantage that may be provided by the integrated unit-operations of this invention. At the end of batching, processing vessel 1100 is empty of product, albeit it needs cleaning. Glycol cooling coil 2300 is at its lower position inside processing vessel 1100 and is soiled with product. To completely remove the product remaining on the walls of processing vessel 1100, vibratory-shear devices 1600 are activated. To remove the product remaining on glycol cooling coil 2300, vibratory-shear devices 2400 are activated. The rotating devices (e.g., large double-cone pump 1200, small double cone pumps 4100, and enhanced high-shear device 3100) as well as high-power sonotrodes 1400 may be rotated/activated to remove the product attached to them.

Following, there is a complete sequence of CIP steps which progresses to rapidly and efficiently clean the apparatus 100. The large double-cone pump 1200 is lifted to the upper position inside top head 2100; simultaneously, rinsing water from spray balls 2600 and spray pipe 2700 is sprayed onto the large double-cone pump 1200 while the pump rotates. During the next CIP step, both the clean large double-cone pump 1200 and spray pipe 2700 are lowered towards processing vessel 1100 while all spraying devices are active. As large double-cone pump 1200 and the spray pipe 2700 are lowered, glycol cooling coil 2300 is lifted towards its upper position to the top head 2100. This up and down pulsating of large double-cone pump 1200 and spray pipe 2700 versus glycol cooling coil 2300 is conducted over several cycles, until the entire top head, including glycol cooling coil 2300, is completely rinsed out. At the end of this step, large double-cone pump 1200 and spray pipe 2700 are at their upper position inside the top head 2100. In the next step, both large double-cone pump 1200 and spray pipe 2700 are lowered to their position inside processing vessel 1100, respectively, pulsated up and down within processing vessel 1100, over several cycles. During this step, a pool of water is allowed to accumulate at the bottom of processing vessel 1100, to a level enough to overflow the direct-cooling flow loop 4000. Furthermore, the other rotating devices (e.g., small double cone pump 4100 and enhanced high-shear device 3100), as well as high-power sonotrodes 1400 are rotated/activated to generate high turbulence within the water pool. The next CIP step achieves a fully rinsed apparatus 100: The water pool at the bottom of processing vessel 1100 is drained, and spray pipe 2700 is retracted to its upper position inside top head 2100. The sequence of CIP steps just described may be repeated with cleaning agents, by utilizing the same mechanical approach.

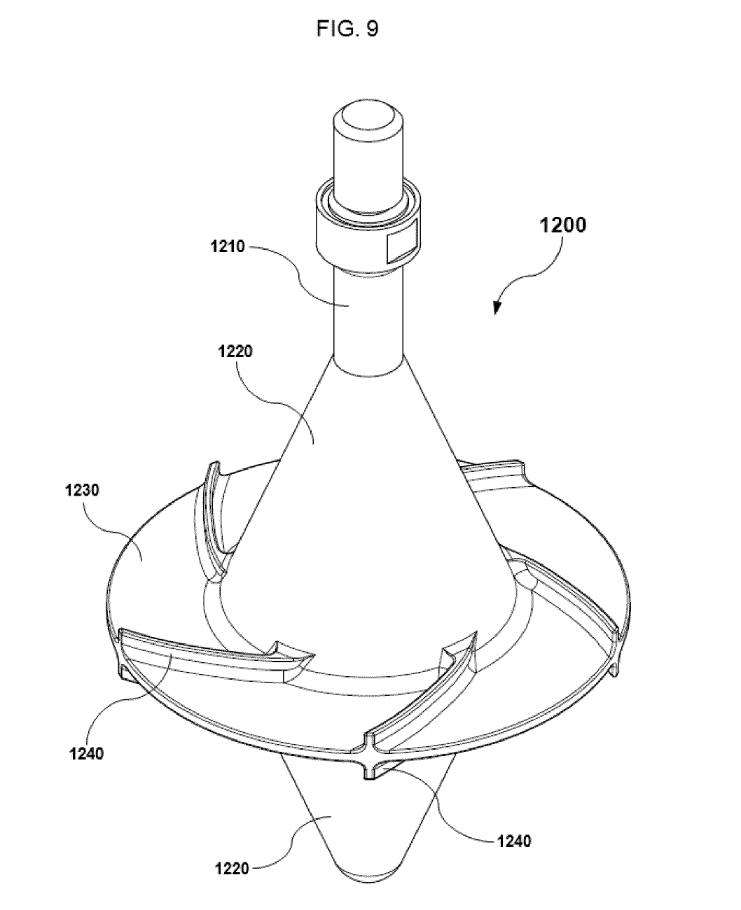

In a preferred embodiment the apparatus comprises a double-cone pump 1200 as shown in FIG. 9. The double cone pump allows pumping of particulates of any size and ensures a large pumping capacity. Large double-cone pump 1200 is made of rotating cones 1220 that are full bodies (as opposed to hollow). Rotating cones 1220 are directly connected to a rotating disc 1230 that additionally displays rotating vanes 1240 on each one of its sides. Unlike rotating double-cone devices (featuring hollow cones) on the market, which are mainly intended for comminution or micronization, the large double-cone pump 1200 provides an efficient pumping that generates a strong internal motion inside processing vessel 1100. Large double-cone pump 1200 and small double-cone pump 4100 preferably have a similar design.

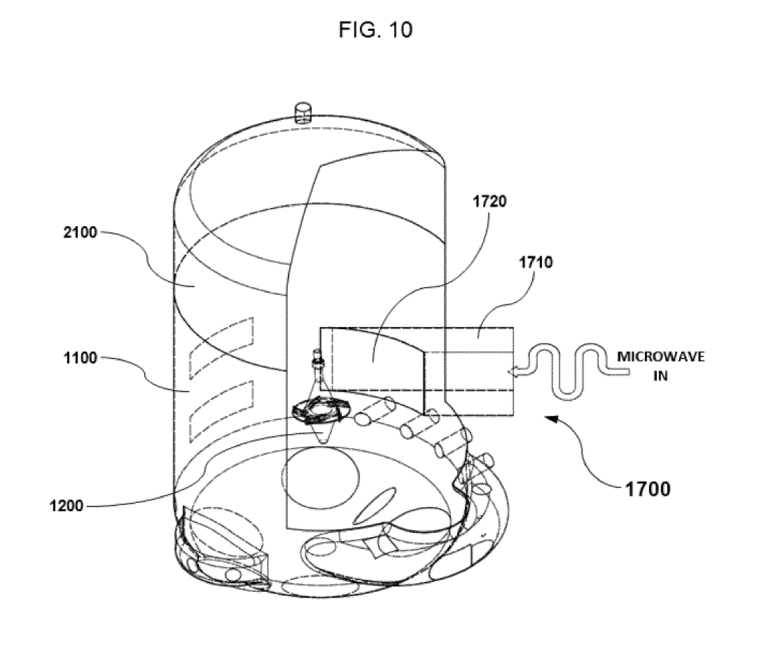

In another preferred embodiment the apparatus of the invention comprises a microwave batch-eating assembly 1700 in FIG. 10, which allows direct heating of liquid products, including products with extremely-high tangent loss factors. As illustrated, the microwave energy is brought inside the processing vessel 1100 via the microwave guide 1710, through a microwave-transparent window 1720. The uniform heating of the contents inside processing vessel 1100 is ensured via the agitation-mixing provided by the large double-cone pump 1200, and a process controlled based upon pulsed microwave energy input.

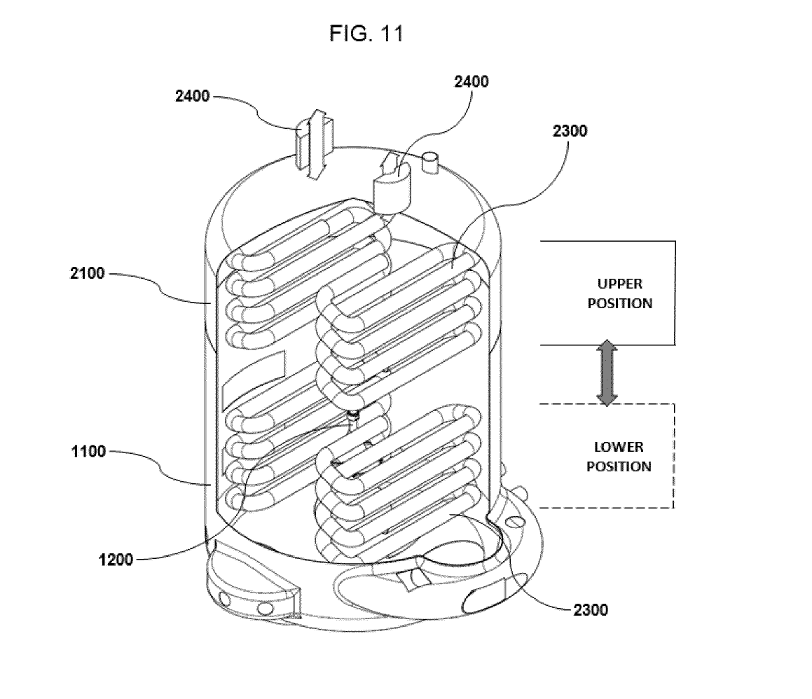

In another preferred embodiment the apparatus of the invention comprises a vibratory-enhanced indirect cooling assembly in FIG. 11. This assembly allows increasing the heat transfer coefficient during cooling of viscous liquid products. The approach comprises an indirect cooling which employs a vibratory-enhanced heat-transfer means in the form of the glycol cooling coil 2300. The glycol cooling coil 2300 made of two symmetrically designed sections is located within the top head 2100, at the “upper position”. None of the mechanical parts located inside the top head 2100 come in contact with the product in the processing vessel 1100 during batching. Instead, when the time for the second cooling stage comes, the glycol cooling coil 2300 is lowered into the processing vessel 1100, at the “lower position” where the cooling of the product is conducted. In addition to allowing for moving up and down between the locations in the top head 2100 and processing vessel 1100, the glycol cooling coil 2300 is provided with vibratory-shear devices 2400. These devices enhance the heat transfer coefficient by acting upon the velocity and thermal boundary layers associated with the heat transfer through the surface of the coil. The intense motion outside the glycol cooling coil 2300 is generated by the large double-cone pump 1200, in conjunction with the small double-cone pump 4100.

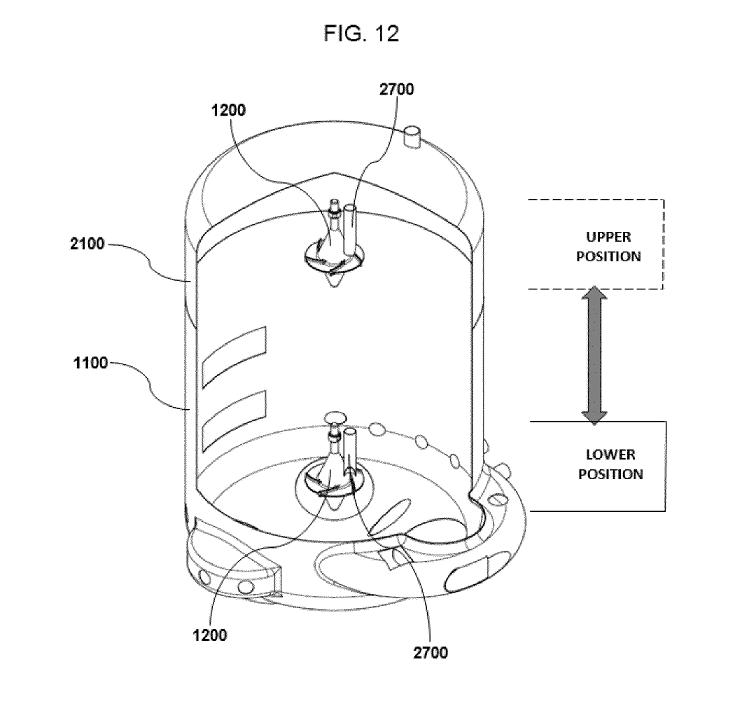

In a further preferred embodiment, the apparatus of the invention comprises a high-velocity spraying assembly for CIP in FIG. 12, which is provided to increase the rate of cleaning-in-place; it originates with the centrifugal force generated by a high-speed rotating device like the large double-cone pump 1200. At the beginning of CIP, large double-cone pump 1200 is lifted to the “upper position”, inside top head 2100, and paired with the spray pipe 2700. When liquid from the spray pipe 2700 falls onto the large double-cone pump 1200, while the pump rotates, the assembly becomes a high-velocity spraying device. During CIP steps, the high-velocity spraying assembly made of the large double-cone pump 1200 and the spray pipe 2700 is pulsated between the “upper position” and the “lower position” as needed to induce and increase the rate of CIP inside the enclosure made of the processing vessel 1100 and top head 2100.

### Advantages of the Invention

The integrated unit-operations concept employed with the present apparatus 100 has two major technical advantages, compared with the state-of-the-art. The first advantage is the physical integration of the apparatus itself, whereby devices for various unit operations are directly installed on the processing vessel 1100, with an un-obstructed (or minimal restriction) communication to processing vessel 1100. The second advantage is the operation- and control-integration of the apparatus, whereby apparatus 100 fulfills a series of conditions: (1) well-stirred reactor; (2) enhanced-shear reactor; (3) enhanced-process-rates reactor; (4) fast-heating reactor; (5) fast-cooling reactor; (6) advanced process-instrumentation reactor; and (7) rapid-efficient-cleaning reactor. In turn, the integrated unit-operations concept ensures that apparatus 100 provides fast, flexible, and economical manufacture of food products, while delivering improved and consistent quality for the final products.

The well-stirred-reactor condition is attained through the combined action of two devices: large double-cone pump 1200; and small double-cone pump 4100. The novel double-cone pumps 1200 and 4100 are purposely advanced for fast and efficient incorporation of solid (powder, granular, particulate) and liquid ingredients. In addition, the small double-cone pump 4100 is designed to achieve locally high volumetric flow rates within the direct-cooling flow loop 4000. Unique to the double-cone pumps 1200 and 4100 is the full-body design of the rotating cones 1220, respectively, the presence of vanes 1240 located on the rotating disc 1230.

The enhanced-shear-reactor condition is mainly accomplished through the novel enhanced-shear device 3100 that operates on the principle of hydrodynamic cavitation typical to high-velocity rotor-stator equipment. Additional contributions to the enhanced-shear reactor condition come from novel supersonic steam-injection nozzles 1500 that operate on the concept of acoustic cavitation typical to direct steam injection equipment. Devices 3100 and 1500 are important to ingredient-incorporation, pre-micronization, and pre-emulsification unit operations. Unique to the enhanced-shear device 3100 is the locating of the stator above the mounting flange; this allows the liquid in the processing vessel 1100 to be drawn from both sides of the rotor-stator assembly 3100.

The enhanced-process-rates-reactor condition is the result of a complex, combined action originating with several devices: enhanced-shear device 3100; supersonic steam-injection nozzles 1500; and an array of high-power sonotrodes 1400 installed at the bottom end of the processing vessel 1100. The high-power sonotrodes 1400 operate on the principle of acoustic cavitation, typical to ultrasound equipment, and are designed to increase the rates of both physical processes (e.g., powder incorporation, micronization, emulsification, etc.) and physicochemical processes (e.g., sugar dissolution, starch gelatinization, protein hydration, fiber hydration, etc.), through Sonochemistry effects. Additional contributions to the enhanced-process-rates-reactor condition may come from heat exchanger 5100, on the direct-heating flow loop 5000, when operating on the concept of ultrasound-energy injection.

The fast-heating-reactor condition is primarily accommodated through the novel supersonic steam-injection nozzles 1500, and additionally through heat exchanger 5100 on the direct-heating flow loop 5000; the latter may be any of the exchangers that operate on the concept of direct volumetric heating like steam-energy-injection, ultrasound-energy injection, or microwave-energy injection. When heating low-viscosity products that have a significant excess of water in their formula, the supersonic steam-injection nozzles 1500 are preferred. By comparison, when heating highly viscous products featuring lower moisture contents, the direct heat exchanger 5100 operating with ultrasound-energy injection or microwave-energy injection has the advantage.

In a special embodiment, the reactor-for-fast-heating condition may be also accommodated through the novel microwave batch-heating assembly 1700; this type of fast heating may be applied to liquid products of different moisture contents; also, microwave batch-heating is designed to accommodate liquid products with extremely-high tangent loss factors. The uniform heating of the contents inside processing vessel 1100 is ensured via the agitation-mixing provided by the large double-cone pump 1200, and a process controlled based upon pulsed microwave energy input. Unique to the microwave batch-heating is the combination among the waveguide 1710, the microwave-transparent window 1720, and the large double-cone pump 1200; the last ensures the temperature uniformity inside the well-stirred processing vessel 1100, even when the tangent loss factors are extremely high.

The rapid-efficient-cleaning-reactor condition is verified by means of two novel approaches; one refers to the internal circulation of the liquid cleaning solutions, the other relates to the external devices employed to release the materials from the surfaces that come in contact with the product during batching. Spraying balls 2600 are installed inside the top head 2000, respectively, a special spray pipe 2700 delivers liquid cleaning solutions directly onto the rotating large double-cone pump 1200. During CIP steps, the high-velocity spraying assembly made of the large double-cone pump 1200 and the spray pipe 2700 is pulsated between an “upper position” and a “lower position” as needed to induce and increase the rate of CIP inside the enclosure made of the processing vessel 1100 and top head 2100. A series of vibratory-shear devices 3500, 3600, 3700 is installed on the present apparatus 100 to induce vibratory shear at the liquid-solid interface, and to enhance product-release and cleaning.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A food-processing apparatus comprising a processing vessel and at least 4 flow loops for unit operations, the flow loops each comprises a product inlet, a product outlet, and a pumping device for circulating the product through the flow loop, the flow loops are directly installed on the processing vessel and in communication with the processing vessel.

2. A food-processing apparatus, according to claim 1, comprising at least 6 flow loops.

3. A food-processing apparatus according to claim 1, wherein the flow loops are selected from the group consisting of: a reactor-vessel flow loop; a top-head flow loop; a high-shear flow loop; a direct-cooling flow loop; a direct-heating flow loop; and a temporary-surge flow loop; and combinations thereof.

4. A food-processing apparatus according to claim 1, wherein the apparatus comprises a reactor-vessel flow loop, a top-head flow loop, a high-shear flow loop, a direct-cooling flow loop, a direct-heating flow loop, and a temporary-surge flow loop.

5. A food-processing apparatus according to claim 1, wherein
the flow loops are either extensions to processing vessel, or recessions to processing vessel, or
in a direct fluid communication with the processing vessel, or a combinations thereof.

6. A food-processing apparatus according to claim 4, wherein the reactor-vessel flow loop comprises at least one device selected from the group consisting of: a processing vessel; a pumping device; sonotrodes; a steam-injection nozzle; pipe port-connections; and a vibratory-shear devices; and combinations thereof.

7. A food-processing apparatus according to claim 4, wherein
the top-head flow loop comprises at least one device selected from the group consisting of: a top head; a cooling device; a vacuum connection; a spray pipe in conjunction with the pumping device; a cleaning device; and a vibratory-shear device; or a combination thereof.

8. A food-processing apparatus according to claim 4, wherein
the high-shear flow loop, adapted to work as a recession to processing vessel, and comprises a high-shear device, at least one hopper, and at least one vibratory-shear device installed at each hopper.

9. A food-processing apparatus according to claim 4, wherein
the direct-cooling flow loop, adapted to work as a recession to processing vessel, comprises at least one device selected from the group consisting of: a pumping device; a liquid-nitrogen injection nozzle; a microwave measurement device; and in-process instrumentation; and combinations thereof.

10. A food-processing apparatus according to claim 4, wherein
the direct-heating flow loop, in fluid communication with processing vessel, comprises at least one device selected from the group consisting of: a direct-heating device operating based on steam-energy-injection, or ultrasound-energy-injection, or microwave-energy-injection; and a circulation pump; and combinations thereof.

11. A food-processing apparatus according to claim 4, wherein
the temporary-surge flow loop, arranged to be in fluid communication with processing vessel, comprises at least one device selected from the group consisting of: a transfer vessel; a transfer pump; a rotating pumping device; a steam-injection nozzle; a series of cleaning-in-place spray balls; and at least one vibratory-shear device; and combinations thereof.

12. A food-processing apparatus according to claim 1, wherein the pumping device is a double-cone pumping device.

13. A food-processing apparatus according to claim 12, wherein the double-cone pumping device comprises:
a rotating flat disc;
two rotating cones, as full physical bodies, with their large bases on the opposite faces of the rotating flat disc; and
at least two rotating vanes located symmetrically onto the opposite sides of the rotating flat disc.

14. A food-processing apparatus according to claim 12, wherein the double-cone pumping device is part of a cleaning-in-place system.

15. A food-processing apparatus according to claim 8, wherein the high-shear device comprises:
a stator featuring two concentric rings having a plurality of axis-parallel teeth, and located inside processing vessel;
a rotor featuring two concentric rings having a plurality of axis-parallel teeth, whose concentric rings intermesh with the concentric rings of the stator; and
at least one rotating vane inside the rotor, which acts as an impeller of a centrifugal pump, allowing liquid intake from both sides of the impeller.

16. A food-processing apparatus according to claim 6, wherein the steam-injection nozzles in the reactor vessel flow loop is a supersonic steam-injection device.

17. A food-processing apparatus, according to claim 1, wherein the processing vessel is heated by means of a microwave batch-heating assembly which comprises:
a microwave guide installed to processing vessel;
a microwave-transparent window installed into the wall of processing vessel; and
a rotating pumping device installed inside processing vessel.

18. A food-processing apparatus according to claim 7, wherein the top head flow loop is provided with a vibratory enhanced cooling assembly comprising cooling devices which are arranged to be lowered, respectively, lifted from the processing vessel.

19. A method of processing food comprising using a food-processing apparatus comprising a processing vessel and at least 4 flow loops for unit operations, the flow loops each comprises a product inlet, a product outlet, and a pumping device for circulating the product through the flow loop, the flow loops are directly installed on the processing vessel and in communication with the processing vessel to process the food.
